(19) United States
(12) Patent Application Publication
(10) Pub. No.: US 2007/0007390 A1
(43) Pub. Date: Jan. 11, 2007

(54) Aircraft door system and method of making and installing the same

(76) Inventor: Alan K. Doerer, Shoreview, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 10/517,031

(22) PCT Filed: Jun. 5, 2003
(86) PCT No.: PCT/US03/17782

§ 371 Date: Sep. 19, 2006

Related U.S. Application Data
(60) Provisional application No. 60/386,992, filed on Jun. 6, 2002.

(51) Int. Cl. B64C 1/14

(52) U.S. Cl. 244/129.5

(57) ABSTRACT

A pre-hung aircraft door (10) and frame assembly (60) having a monolithic aircraft door (10) and a monolithic aircraft door frame (60), a method of manufacturing such aircraft door and frame assembly and a method of installing such aircraft door and frame assembly to the fuselage of an aircraft.

### FIELD OF THE INVENTION

The present invention relates to structural aircraft components and methods of making and installing the same. More specifically, the present invention relates to a pre-hung door frame assembly for an aircraft comprising a monolithic door and a corresponding monolithic door frame and a method of making and installing such assembly.

### BACKGROUND OF THE INVENTION

Structural components in aircraft must be manufactured and installed with a high degree of precision. Aircraft doors are no different; however, when it comes to attaching a door to an aircraft the current process is remarkably complex and difficult. This is made more difficult because commercial aircraft are generally not mass produced. That is, each aircraft is individually fabricated. Essentially the fuselage of the aircraft is constructed using a plurality of fuselage hoops and lateral support stringers, with rough openings provided for the doors. An oversized door is then brought inland “rigged” to fit the door opening for which it is intended. That is, excess portions of the door are cut away until it fits the opening. Even then, the door is often twisted, stressed and stretched during the installation and fitting process. In addition, numerous shims are used to position and retain the door in the proper position. Accordingly, each door of an aircraft is custom fit and to some extent custom made as it is being installed. A typical installation for a passenger door takes as much as 30 hours or more to complete and costs about $150,000. Should the door ever become damaged and need to be replaced, the entire process must be repeated.

A typical commercial aircraft door itself is a very complicated component often formed from sheet metal pieces and having as many as 60-100 different parts and as many as 1000 or more fasteners. In addition to the required structural components, each door may also be provided with various seals, hinges, latches, releases, handles and other appropriate components. In any one aircraft, there are usually one or more main passenger access points, service access points, a plurality of emergency exits, luggage compartments, cargo areas, service covers and any number of other access areas that must have doors or other similar custom fit covers. Most such doors include the complicated structure and the installation procedure described above.

### BRIEF SUMMARY OF THE INVENTION

In one embodiment, the present invention is a pre-hung aircraft door assembly that includes an aircraft door and a matching, corresponding frame. The frame and the door can be made to precise tolerances assuring proper mating. Thus, the frame can be installed within a rough opening within the aircraft fuselage and the aircraft door can be quickly and easily coupled with the frame. Should any problem subsequently occur with the door, it can be quickly and easily replaced with a standardized aircraft door. Such a pre-hung aircraft door assembly can be manufactured and installed with significant savings compared to current manufacturing and assembly costs.

Further, by using high velocity machining to fabricate monolithic aircraft doors and frames, even greater quality and higher tolerances can be achieved. In addition, by forming, e.g., cold forming, the various components prior to high velocity machining, various stresses within the component can be reduced or eliminated when compared with other manufacturing techniques.

Accordingly, in a preferred embodiment, the present invention is an aircraft door and frame assembly that has an aircraft door and an aircraft door frame configured to receive the aircraft door, wherein the aircraft door is matched with the aircraft door frame.

In another embodiment, an aircraft door and frame assembly is provided that has an aircraft door having a latch mechanism. The assembly further has an aircraft door frame having an outer peripheral edge configured to be received and secured within a rough opening in an aircraft fuselage. The frame is provided with a door receiving opening having an inner edge and a flange configured to receive the aircraft door.

In another embodiment a method of installing an aircraft door into an aircraft is provided. The method includes providing a pre-constructed aircraft with a rough opening for a door within the fuselage. The method also includes securing the aircraft door frame within the rough opening and attaching a pre-constructed and unaltered aircraft door to the aircraft door frame, wherein the aircraft door and the aircraft door frame have been manufactured to fit together as complimentary components.

In another embodiment, a method of manufacturing an aircraft door and frame assembly of the type which includes a monolithic door component and a monolithic frame component. The method includes providing an aircraft door workpiece and an aircraft door frame workpiece and cold forming the aircraft door workpiece and the aircraft door frame workpiece. The method also includes machining the aircraft door and door frame workpieces utilizing high velocity machining after cold forming, to produce the individual door and door frame components, and thus the aircraft door and frame assembly, with the aircraft door being matched to the aircraft door frame.

In another embodiment, a method of manufacturing an aircraft door and frame assembly, including a monolithic door component and a monolithic frame component is provided. The method includes rough machining a first piece of stock for an aircraft door, forming the first piece of stock and then clamping the first piece of stock for semi-finish machining. After semi-finishing, the clamping is released and then reclamped for final finish machining. For the manufacture of the monolithic frame component, the above process is repeated using a second piece of stock.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an isometric view of a monolithic door of the present invention as viewed from the interior.

FIG. 2 is an isometric view of the monolithic door of FIG. 1 as viewed from the exterior.

FIG. 3 an isometric view of a monolithic frame assembly of the present invention as viewed from the interior.

FIG. 3A is an isometric view of an assembled door and frame assembly as viewed from the interior of the assembly.

FIG. 3B is an isometric view of an assembled door and frame assembly as viewed from the exterior of the assembly.

FIG. 4 is an isometric view of the monolithic door and monolithic frame assembled together within a plurality of fuselage hoops.

FIG. 5 is an elevational plan view showing the interior of an assembled and installed monolithic door and frame assembly.

FIG. 6 is a side view, partially in section, of an assembled monolithic door and frame assembly.

FIG. 7 is a top view, partially in section, of an assembled and installed monolithic door and frame assembly.

FIG. 8 is an enlarged, fragmentary view of an interior portion of an assembled monolithic door and frame assembly illustrating a locking pin locking the door and frame.

FIG. 9 is an enlarged fragmentary view, partially in section, as viewed from the top and cut through the pin of an interior portion of an assembled monolithic door and frame assembly illustrating the components of a locking pin.

FIG. 10 is an enlarged fragmentary view, partially in section, of an assembled and installed monolithic door and frame assembly showing the relationship of the seal with an installed door and door frame.

### DETAILED DESCRIPTION

The various embodiments of the present invention provide a pre-hung aircraft door and a corresponding door frame. Because doors can be provided as passenger doors, service doors, cargo doors, emergency exit doors, luggage compartment doors, hatches, covers and the like, the particular configuration of a given door can vary. In general, the term “aircraft door” is meant to refer to any of these kinds or types of doors and accordingly would include any standard, necessary or desirable components that are provided with such a door. Although the present invention is applicable to any of various aircraft doors, the preferred embodiment will be described with respect to an emergency exit or cargo door.

Further, the term “monolithic” as used herein is given its normal meaning as being formed substantially as a single piece, without joints or seams.

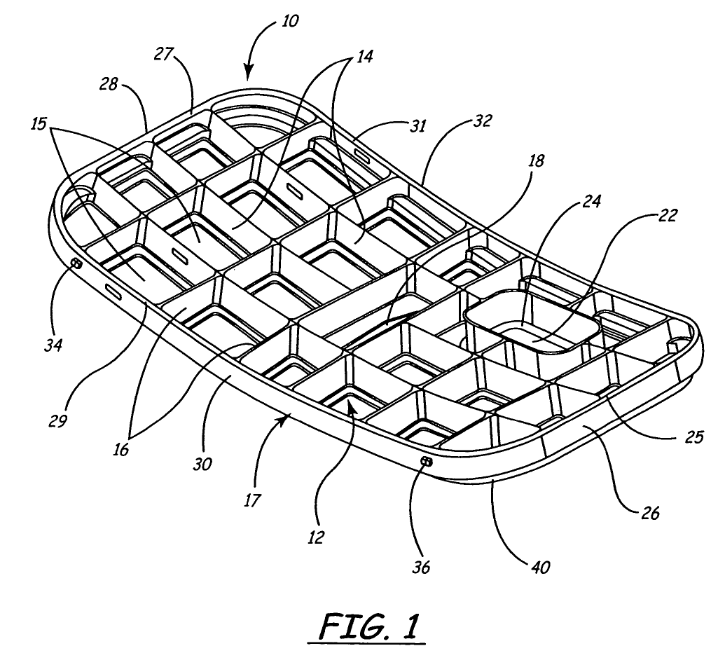

FIG. 1 is an isometric view showing the interior portion of a monolithic aircraft service door 10. The door 10 is formed from a single piece of material with a high degree of precision. The monolithic door 10 includes an interior door panel 12 with a top wall 25, a bottom wall 27 and a pair of side walls 29, 31. These walls define a top edge 26, a bottom edge 28 and a pair of side edges 30 and 32, respectively. Running from the top edge 26 to the bottom edge 28 of the door 10 are a plurality of longitudinally extending integral ribs 14. Running from a first side edge 30 to a second side edge 32 are a plurality of laterally extending integral ribs or stringers 16. The ribs 14 and stringers 16 form a plurality of compartments 15 that include portions of the interior door panel 12. The ribs 14 and stringers 16 provide rigidity and structural support to the door 10 while minimizing its weight and volume. The top edge 26, the bottom edge 28, and the side edges 30, 32 collectively define an outer peripheral edge 17 of the monolithic door 10. In the preferred embodiment, adjacent edges meet to form a curved or rounded corner, however, such corners may be squared if desired.

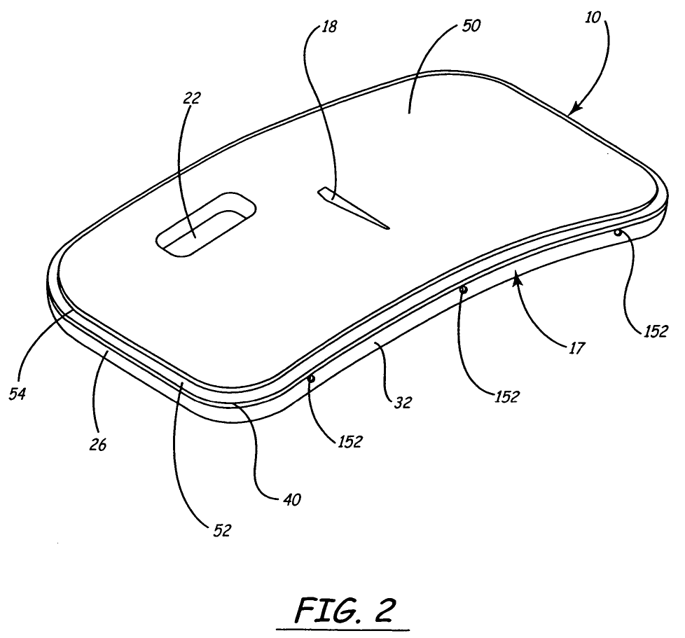

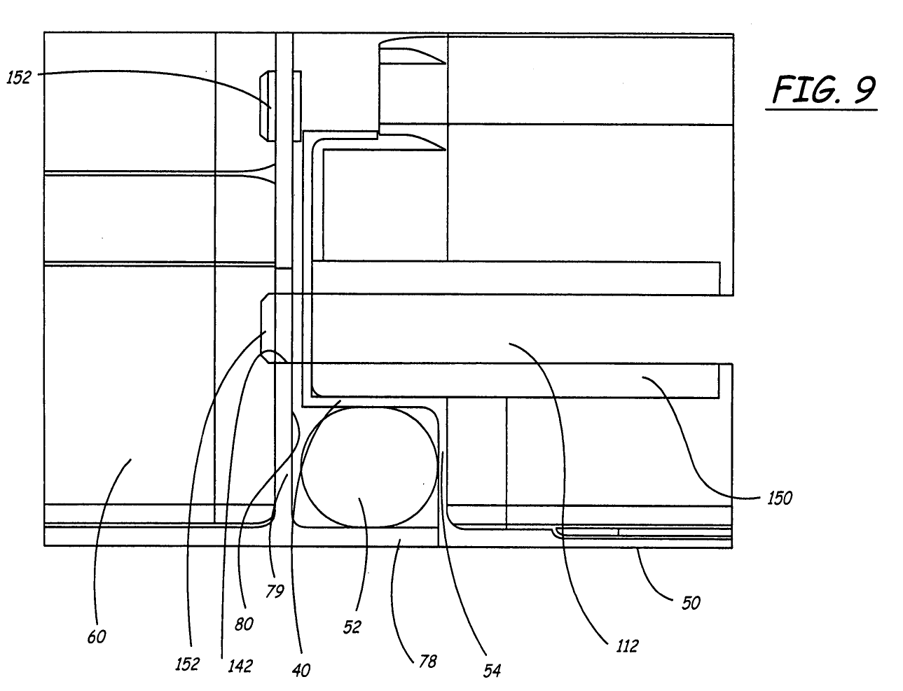

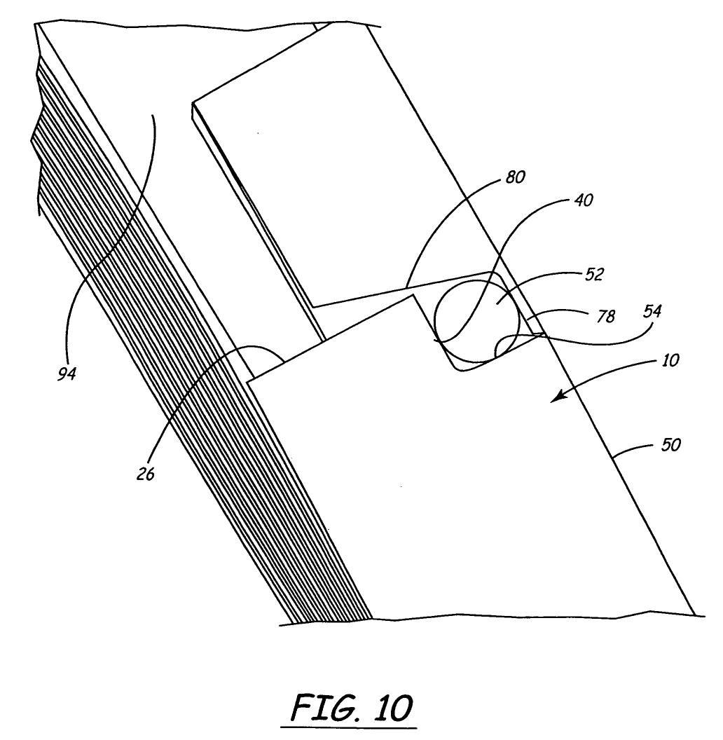

FIG. 2 is an isometric view showing the exterior portion of the monolithic service door 10. The door is provided with a substantially planar exterior surface 50 and a seal receiving seat formed between the outer peripheral edge 17 and an outer edge of the surface 50. As best shown in FIGS. 2, 9 and 10, the seal receiving seat is defined by a pair of seat surfaces 40 and 54 which together provide a seating surface for a seal 52. As shown in FIG. 9, the seat surface 40 joins with the peripheral edge 17, while the seat surface 54 joins with the exterior surface 50 of the door 10. The seal 52 engages the surfaces 40 and 54 and is positioned between the door 10 and an opposing surface of the door frame as will be described in greater detail below to form a seal between the door and such door frame. Preferably, the exterior surface 50 of the door 10 comprises the exterior surface of the aircraft and thus is coplanar with the adjacent exterior surface of the door frame, hereinafter described, and the aircraft. Alternatively, a separate skin can be added to the door 10 as a separate component, if desired.

As shown best in FIG. 1, a plurality of door stops 34,36 may be provided around the periphery of the door. These stops function to properly position the door within the door frame and to provide the desired amount of compression on the seal 52 when the door is installed. The stops 34,36 may be integrally machined into the outer edge 17 of the door or may be attached as a separate component.

The monolithic door 10 as shown in FIGS. 1 and 2 is in a pre-assembled state, that is, the door 10 is shown as a singular component without the attachment of additional components. Additional components would then be attached. For example, in the preferred embodiment, a latch handle assembly opening 18 and a latch handle assembly opening flange 20 are provided so that a latch assembly can be installed on the service door 10. Similarly, other components may also be connected to the door as needed. For example, while not separately shown, many aircraft doors (such as passenger and baggage compartment doors) will be interconnected to a frame with a hinge assembly. One half of such hinge assembly will be connected to a portion of the door. FIG. 2 shows the door with a latch mechanism installed and with the ends 152 of the latch pins extending outwardly from the outer edge 17 of the door.

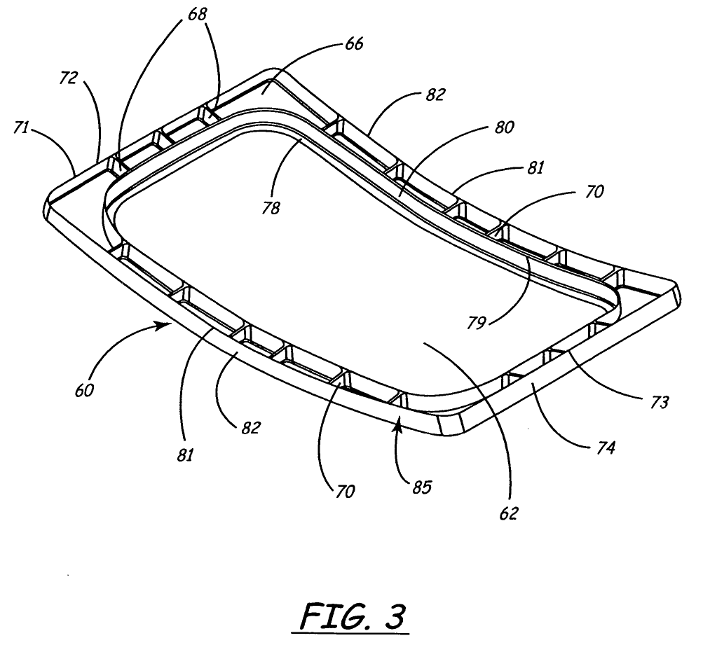

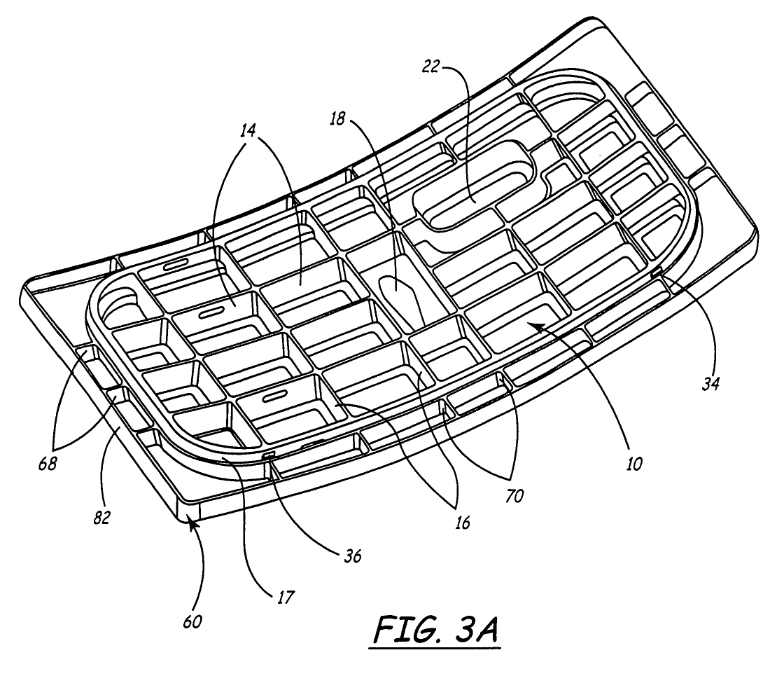

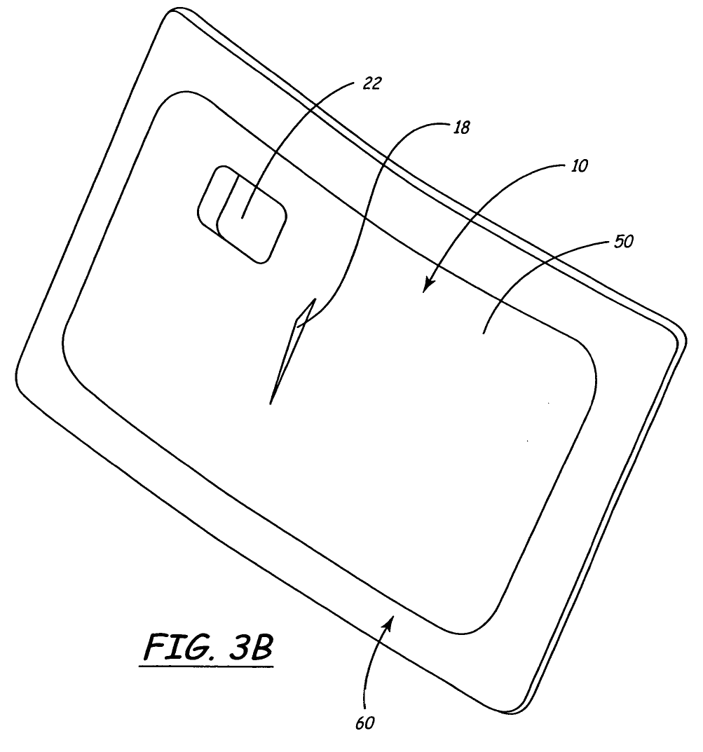

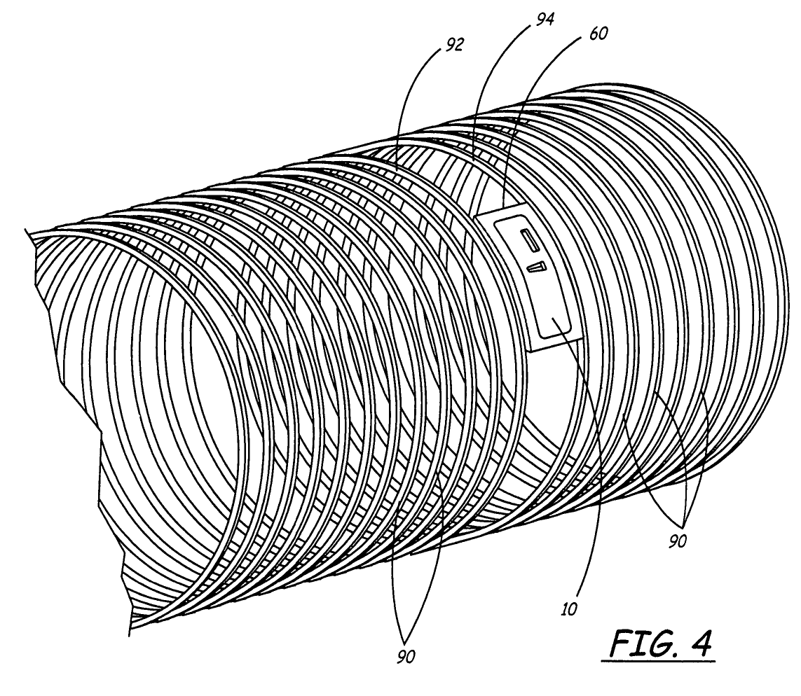

FIG. 3 is an isometric view showing an interior of a monolithic door frame 60. The frame 60 is a singular component having an interior frame panel 66. Integrally formed with the interior frame panel are a plurality of frame ribs 68 and frame ribs or stringers 70. The frame ribs 68 and frame stringers 70 provide rigidity and structural support to the monolithic frame 60 while minimizing its weight and volume. The frame includes a top outer wall 71, a bottom outer wall 73 and a pair of side outer walls 81,81. These walls define a top edge 72, a bottom edge 74 and a pair of side edges 82,82, respectively, which in turn define the outer peripheral edge 85 of the frame. Although not shown in FIG. 3, but shown in FIGS. 3B and 4, the exterior surface of the frame 60 is substantially planar. Like the door 10, the exterior surface of the frame 60 is substantially coplanar with the adjacent exterior surface of the aircraft.

A door receiving opening 62 is provided within the frame 60. This opening is sized and configured to receive the monolithic door 10. The door opening 62 is defined by the inner edge 80 of the wall 79. The edge 80 is continuous and is spaced inwardly from the outer peripheral edge 85. In the preferred embodiment as shown, the ribs 68 and stringers 70 are integrally formed with the inner and outer walls and are positioned at right angles to these walls.

The door opening 62 includes an inwardly extending frame flange 78 which functions as a seat for the seal member 52. As shown best in FIG. 9, the flange 78 has an outer surface coplanar with the outer surface of the frame and an inner surface which provides a seat for the seal 52. When the door 10 is in a closed position as shown in FIG. 9, the seal member 52 is captured in sealing relationship between the flange 78 and the seat surfaces 40 and 54 of the door.

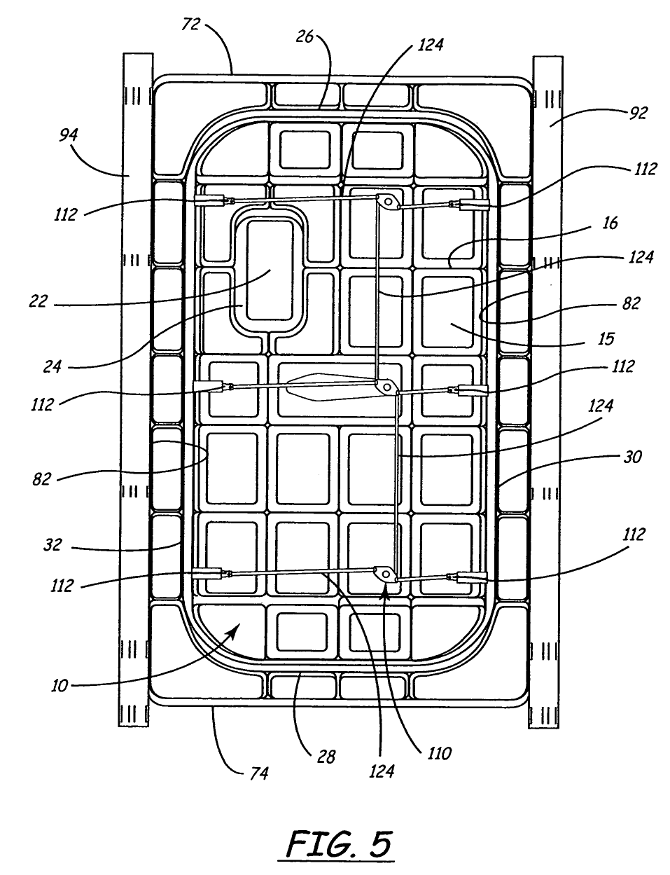

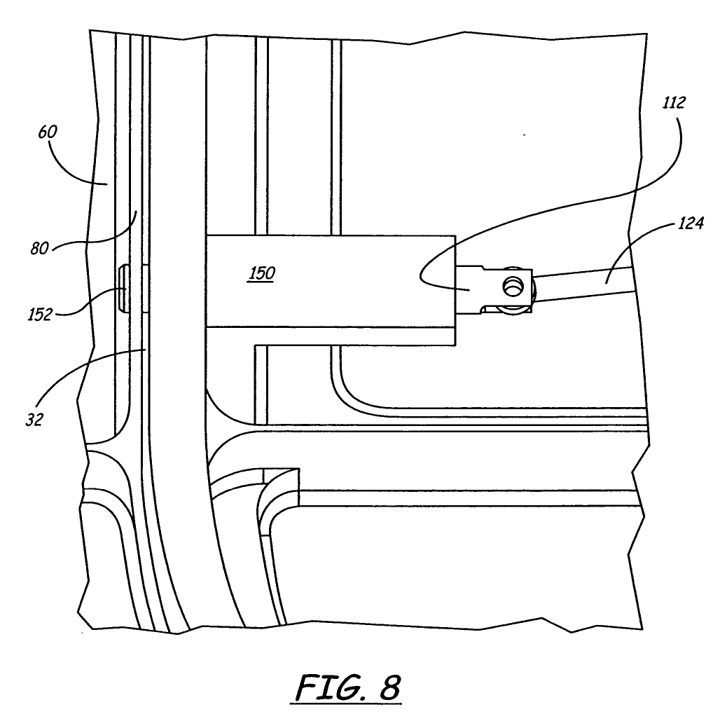

Because the door 10 and the door frame 60 are manufactured to exact tolerances, the door 10 fits perfectly within the door opening 62 without modification of the door 10 or the frame 60. The door 10 and frame 60 illustrated in FIGS. 1, 2, 3, 3A and 3B is the type of door that would typically be used as an emergency exit or a cargo door. This type of door is usually pulled into the interior of the aircraft in order to open or gain access to the door opening. To close the door 10, the door is pushed outwardly relative to the aircraft and into the frame opening 62. The plurality of door stops 34 and 36 provided along the peripheral edge 17 of the door engage a portion of the frame (as shown best in FIG. 3A) to insure proper positioning of the door 10 within the frame 60 and proper compression of the seal 52. When in a closed position, the door 10 is maintained in such position by a latch assembly 110 shown best in FIGS. 5, 7 and 8. The latch assembly 110 includes a plurality of movable linking arms 124 that are coupled with a handle assembly (not shown). The linking arms are coupled with a plurality of locking pins 112. The locking pins 112 are movable between an engaged position in which an outer end 152 of the pins 112 pass through aligned openings in the door 10 and the frame 60 so that relative movement between the frame 60 and the door 10 is prevented and a disengaged position in which the pins 112 are retracted.

While various methods exist for producing a monolithic component such as the aircraft door 10 or the aircraft door frame 60, a particularly advantageous method is disclosed in commonly assigned copending PCT Application PCT/US01/48176, the substance of which is incorporated herein by reference in its entirety. As described therein, processes are provided for forming and machining a piece of stock to produce a monolithic product. In particular, the process can be used to form a product having an outer surface and a frame comprised of ribs and stringers.

In general, the process of the present invention combines the cold forming of relatively thin raw material or stock material with high velocity machining. High velocity machining moves a tool at a relatively high rate of speed across or over the surface of a work piece, with the tool or working head operating at a relatively high rate of revolution. High velocity machining generally provides less distortion and stresses to the material than conventional machining.

With the process of the present invention, parts are first cold formed then machined with high velocity machining. Thus, any distortion of the formed work piece after machining is reduced when compared to conventional machining, and any movement of the part after machining is more predictable, and may be calculated into the overall manufacturing process. Furthermore, the release of stress after finish machining can be anticipated and accurately modeled. Thus, the machining tools and/or software can be programmed to analyze or calculate the resultant stresses and movement and to actually model the machining step to achieve the best result. This allows for the formation of a thinner final monolithic product which has strength and weight advantages over thicker products produced with conventional machining. The process can be performed on five axes with minimal residual stress.

The aircraft door 10 of FIGS. 1 and 2 and the frame 60 of FIG. 3 can be fabricated by this process. First, a stock plate for each of the door 10 and the frame 60 is rough machined, leaving enough material to provide for cleanup or finish machining and for any desired additional features such as door stops and the like. Gauge points and attachment features, such as tooling holes, tapped holes and the like, may be provided or machined into the part.

The component is then fixtured (i.e., clamped or otherwise held relative to a forming fixture or device or machine tool) for semi-finish machining, preferably without inducing any deflection into the component. The component is semi-machined and clamping is released. This allows the component to find a neutral position or condition and to release any internal stresses. The component is then re-clamped, again preferably without inducing any deflection.

Next, the component is finish machined to the point where the final machined contour is such that any residual movement in the component during finish machining leaves the finished component and/or component surface within selected tolerances. The component is then turned over, fixtured and clamped by vacuum or a mechanical device and all remaining features are finish machined. The component is then released from the fixture, deburred and finish treatments applied. Peripheral equipment or components are then attached. Any monolithic aircraft component, such as the door 10 or the door frame 60 can be fabricated with this process.

Having described the structure of the aircraft door assembly and the preferred method of making the same, the assembly of the door and frame and the installation of the assembly into an aircraft can be understood as follows. With reference to FIG. 4, a conventional aircraft body is formed using a series of fuselage hoops 90 to provide the structural support for the aircraft fuselage. These hoops 90 are usually interconnected with a plurality of stringers (not shown) extending laterally between the fuselage hoops 90. The various components of the aircraft, including the exterior skin of the fuselage, are then attached to these fuselage hoops 90 and stringers. Commercial aircraft are generally not mass produced, but instead are custom made. That means, that substantial differences will exist from one aircraft to another, thereby making it difficult to realize any sort of dimensional standardization. For example, although the spacing between the fuselage hoops 90 is intended to be the same for each aircraft, this spacing can vary from one aircraft to another. Further, because the hoops are constructed of sheet metal, their dimensions will vary beyond acceptable tolerances needed to receive a presized door. Accordingly, because aircraft doors must fit between such hoops, oversized aircraft doors are provided and custom fit to a space between the fuselage hoops.

With the present invention, a very precisely fabricated, presized door and frame assembly 60 is seated between a first hoop 92 and a second hoop 94. While variances in the spacing between the hoops and the dimensions of the hoops themselves will continue to exist, the frame 60 can be mounted within the fuselage frame much more easily than the door without the frame. Accordingly, because the monolithic door frame and door are manufactured to exact tolerances relative to each other, these tolerances will be maintained after installation of the frame so that a matched, standardized monolithic aircraft door 10 can be attached without requiring modification of either the frame 60 or the door 10.

FIG. 5 shows an assembled monolithic door 10 and door frame assembly 60 mounted to an aircraft fuselage. Specifically, as shown, the frame 60 is positioned between a pair of adjacent hoops 92 and 94. Preferably, the width of the frame 60 approximates or is slightly less than the distance between the hoops 92 and 94. If needed, shims or other conventional spacers are positioned between the peripheral edge of the frame and the adjacent edges of the hoops 92 and 94. Then, the frame 60 can be securely fastened to the hoops 92, 94 using various conventional fasteners such as rivets or welds. Holes for the rivets can be pre-formed into the frame 60 to avoid inducing cracking in the monolithic component. An appropriate seal is formed between the hoops 92, 94 and the frame 60. This seal can be formed from a caulking compound or other resilient material as desired and as known in the art.

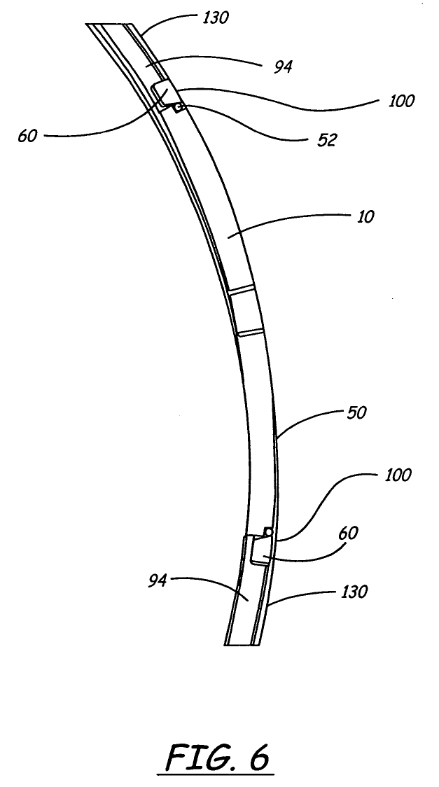

FIG. 6 is a side, sectional view of an assembled and installed monolithic door and door frame assembly. The monolithic door 10 includes surface 59 of the door that is coplanar with an exterior surface 100 of the frame 60. The fuselage also includes an exterior surface 130 which is coplanar with both the exterior door surface 50 and the exterior frame surface 100. While each component could include its own external surface or skin, other alternative arrangements are possible. For example, a portion of the fuselage skin 130 could be extended to cover the exposed exterior surface of the frame 60.

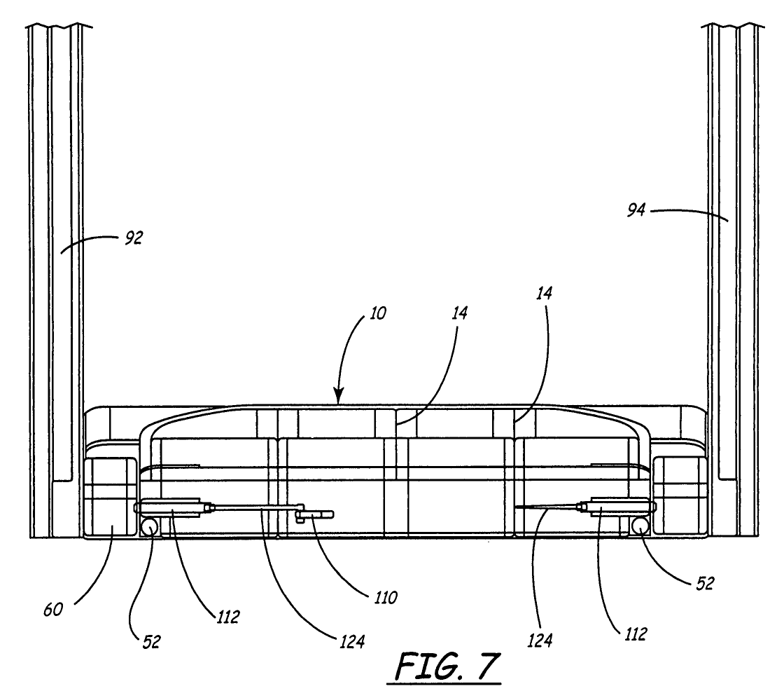

FIG. 7 is an end, sectional view of an assembled and installed monolithic door and frame assembly that illustrates how the locking pins 112 engage the door 10 and frame 60. FIG. 9 is an enlarged, fragmentary view of FIG. 7. As shown in FIGS. 7, 8 and 9, each of the locking pins 112 is slidably received in a locking pin support 150 mounted to the door 10. As shown, one end of each locking pin is coupled to a linking arm 124, while the other end 152 is designed to move between an engaged and disengaged position relative to the frame 60. When engaged, the end 152 passes through a slot 142 in the wall 79. When disengaged, the end 152 is retracted into the support 150.

Although the present invention has been described with reference to preferred embodiments, persons skilled in the art will recognize that changes may be made in form and detail without departing from the spirit and scope of the invention.

We claim:

1. An aircraft door and frame assembly comprising:
an aircraft door; and
an aircraft door frame having a door receiving opening to receive said aircraft door.

2. The aircraft door and frame assembly of claim 1 wherein said aircraft door frame is an outer frame edge for connection within a rough opening in a fuselage of an aircraft.

3. The aircraft door and frame assembly of claim 2 wherein said aircraft door is monolithic and said aircraft door frame is monolithic.

4. The aircraft door and frame assembly of claim 1 wherein the aircraft door has an outer panel integrally formed with a plurality of ribs and a plurality of stringers.

5. The aircraft door and frame assembly of claim 1 including a latch mechanism connected with said aircraft door.

6. The aircraft door and frame assembly of claim 1 further including:
a door stop pin coupled with said aircraft door;
a door stop pad coupled with the aircraft door frame, said stop pin and stop pad being aligned with one another to limit the movement of said aircraft door relative to said aircraft door frame.

7. The aircraft door and frame assembly of claim 1 including a seal between said aircraft door and said aircraft door frame.

8. The aircraft door and frame assembly of claim 1 wherein said aircraft door is one of an emergency exit or cargo door.

9. The aircraft door and frame assembly of claim I wherein said door receiving opening includes an inwardly extending seal flange.

10. The aircraft door and frame assembly of claim 1 wherein said aircraft door includes an outer peripheral edge and a seal seat provided adjacent to said outer peripheral edge for engagement with said seal.

11. The aircraft door and frame assembly of claim 10 wherein said door receiving opening includes an inwardly extending seal flange.

12. A method of installing an aircraft door into an aircraft comprising:
providing a rough opening with a pre-constructed fuselage of an aircraft;
providing a prehung aircraft door and frame assembly including an aircraft door and an aircraft door frame;
securing said aircraft door frame within said rough opening; and
mounting said aircraft door to said aircraft door frame.

13. The method of claim 12 including mounting said aircraft door to said aircraft door frame without modification of said aircraft door.

14. A method of manufacturing an aircraft door and frame assembly of the type comprising a monolithic door component and a monolithic door frame component, the method comprising:
providing an aircraft door workpiece and an aircraft door frame workpiece;
cold forming said aircraft door workpiece and said aircraft door frame workpiece; and
machining said aircraft door workpiece and said aircraft door frame workpiece utilizing high velocity machining after said cold forming.

15. A method of manufacturing an aircraft door and frame assembly which includes a monolithic door component and a monolithic door frame component, the method comprising:
rough machining a first piece of stock for said aircraft door component;
rough machining a second piece of stock for said aircraft door component;
forming said first piece of stock;
forming said second piece of stock;
clamping said formed first piece of stock for semi-finish machining and semi-finish machining said first piece of stock;
releasing and reclamping said first piece of stock;
finish machining said first piece of stock to form said aircraft door component;
clamping said formed second piece of stock for semi-finish machining, and semi-finish machining the second piece of stock;
releasing and reclamping said second piece of stock; and
finish machining said second piece of stock to form said aircraft frame component.

16 The method claim 15 including deburring and applying finish treatments to said first and second pieces of stock.

17. The method of claim 15 wherein said aircraft door component includes an outer panel and a support frame including a rib and a stringer

18. The method of claim 15 wherein aircraft door frame component includes an outer panel and an interior perimeter and a rib.

19. An aircraft comprising:
a fuselage frame structure; and
a prehung door assembly mounted to said frame structure, said door assembly comprising;
an aircraft door, and
an aircraft door frame having a door receiving opening to receive said aircraft door.

20. The aircraft of claim 19 wherein said aircraft door is monolithic and said aircraft door frame is monolithic.
